(19) United States
(12) Patent Application Publication
(10) Pub. No.: US 2016/0123217 A1
(43) Pub. Date: May 5, 2016

(54) CONTROL VALVE SYSTEM FOR COOLANT

(71) Applicant: HYUNDAI MOTOR COMPANY, Seoul (KR)

(72) Inventors: Yoonghwa PARK, Seongnam-si (KR); Jong Ho LEE, Yongin-si (KR); Byung Ok PARK, Hwaseong-si (KR)

(21) Appl. No.: 14/857,805

(22) Filed: Sep. 17, 2015

(30) Foreign Application Priority Data
Oct. 31, 2014 (KR) 10-2014-0150107

(51) Int. Cl. F01P 7/14; F16K 31/00

(52) U.S. Cl. CPC F01P 7/14; F16K 31/002; F01P 2007/146

(57) ABSTRACT

A control valve system for a coolant includes an inlet through which a coolant flows into a water chamber. A plurality of outlets discharges the coolant outside the water chamber. A valve housing defines the water chamber which is fluidically connected to the inlet and the plurality of outlets. At least one rotary valve is rotatably installed in the water chamber. An actuator rotates the rotary valve. A controller is configured to control a flow rate of the coolant discharged to the plurality of outlets by adjusting a rotational angle of the rotary valve by the actuator. The plurality of outlets include a first outlet connected to a radiator which cools the coolant, and a second outlet connected to a reservoir tank which removes bubbles of the coolant.

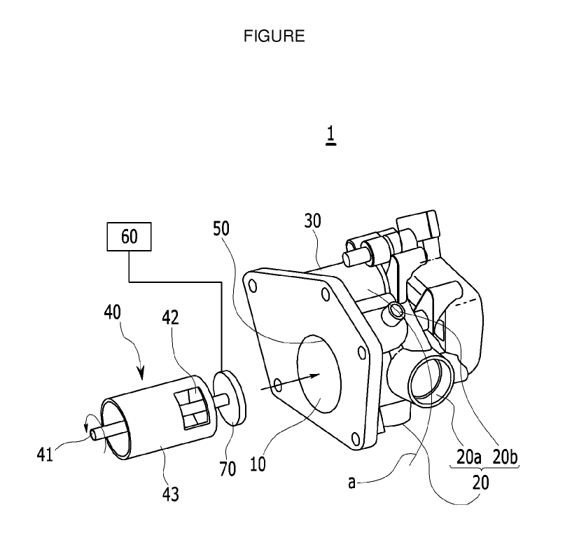

### CROSS-REFERENCE TO RELATED APPLICATION

This application claims the benefit of priority to Korean Patent Application No. 10-2014-0150107 filed in the Korean Intellectual Property Office on Oct. 31, 2014, the entire content of which is incorporated herein by reference.

### TECHNICAL FIELD

The present disclosure relates to a control valve system for coolant, and more particularly, to a control valve system for a coolant which controls a coolant flow of an engine cooling system.

### BACKGROUND

An engine rotates a crankshaft by power generated by combustion of fuel and emits heat energy through a coolant line. A coolant absorbs the heat energy while circulating through the coolant line including an engine, a heater, and a radiator and emits the absorbed heat energy to outside.

When a coolant temperature of the engine is low, viscosity of oil increases and a frictional force increases. As a result, fuel consumption tends to increase, a temperature of exhaust gas slowly increases, an activation time of a catalyst increases, and quality of the exhaust gas may deteriorate. Further, a period of time during which a function of the heater is normalized may increase.

In general, a pressurized type coolant line is frequently used because the pressurized type coolant line has advantages in discharging of bubbles generated in the coolant as compared with an open-to-air type line. In the open-to-air type coolant line, since the bubbles are discharged to the outside only when a pressure cap is opened, the coolant boils over during stop after high-load operation.

In the pressurized type coolant line in the related art, a degassing line, that is, a bubble discharge line through which coolant is flowing all the time to increase cooling efficiency by discharging the bubbles in the coolant. Further, the coolant flowing through the bubble discharge line all the time is added, and thus, there is a delay in engine warm-up. As a result, fuel efficiency of the heater deteriorates. For example, for rapid warm-up, the coolant needs to absorb the heat, and the bubble discharge line which is the line through which coolant flows all the time is added to discharge the heat.

The problem becomes particularly serious in a diesel engine in which the rapid warm-up is important.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

The present disclosure has been made in an effort to provide a control valve system for a coolant having advantages of improving fuel efficiency and reducing a weight and cost by shortening an engine warm-up time and reducing constituent components as compared with an existing pressurized type coolant line.

According to an exemplary embodiment of the present inventive concept, a control valve system for a coolant includes an inlet through which a coolant flows into a water chamber. A plurality of outlets discharges the coolant outside the water chamber. A valve housing defines the water chamber which is fluidically connected to the inlet and the plurality of outlets. At least one rotary valve is rotatably installed in the water chamber. At least one actuator rotates at least one rotary valve. A controller is configured to control a flow rate of the coolant discharged to the plurality of outlets by adjusting a rotational angle of at least one rotary valve by at least one actuator. The plurality of outlets include a first outlet connected to a radiator which cools the coolant, and a second outlet connected to a reservoir tank which removes bubbles of the coolant.

At least one rotary valve may include a valve shaft connected to at least one actuator, and a valve body having at least one through-hole which communicates with each of the plurality of outlets by rotating the valve shaft. The valve body is fixedly coupled with the valve shaft.

The flow rate of the discharged coolant may be determined according to an area in which at least one through-hole and the plurality of outlets overlap with each other.

The controller may discharge the coolant to the first outlet when a temperature of the coolant is a first temperature or more.

The controller may discharge the coolant to the second outlet when a temperature of the coolant is a second predetermined temperature or more.

The first outlet and the second outlet may be positioned on a virtual cross line of a plane which is vertical to an axis of rotation of at least one rotary valve and the valve housing.

A front end of the reservoir tank may be connected with the second outlet, and a rear end of the reservoir tank may be connected to a water pump which circulates the coolant by pressurizing the coolant.

At least one actuator may be a motor.

### BRIEF DESCRIPTION OF THE DRAWING

The FIGURE is a perspective view illustrating constituent elements and positions of a first outlet and a second outlet of a control valve system for a coolant according to an exemplary embodiment of the present inventive concept.

### DETAILED DESCRIPTION OF THE EMBODIMENTS

The present invention will be described more fully hereinafter with reference to the accompanying drawings, in which exemplary embodiments are shown.

As those skilled in the art would realize, the described embodiments may be modified in various different ways, all without departing from the spirit or scope of the present disclosure.

Unless explicitly described to the contrary, the word “comprise” and variations such as “comprises” or “comprising” will be understood to imply the inclusion of stated elements but not the exclusion of any other elements. Further, a name of a constituent element does not limit a function of the corresponding constituent element.

The FIGURE is a perspective view illustrating constituent elements and positions of a first outlet and a second outlet of a control valve system for a coolant according to an exemplary embodiment of the present inventive concept.

Referring to the FIGURE, a control valve system 1 for a coolant according to an exemplary embodiment of the present inventive concept may include an inlet 10 through which a coolant flows into a water chamber 50, a plurality of outlets 20 discharging the coolant outside the water chamber 50, a valve housing 30 defining the water chamber 50 which is fluidically connected to the inlet 10 and the plurality of outlets 20, at least one rotary valve 40 which is rotatably installed in the water chamber 50, at least one actuator 70 rotating the at least one rotary valve 40, and a controller 60 controlling a flow of the coolant discharged to the plurality of outlets 20 by adjusting a rotational angle of the at least one rotary valve 40 by the at least one actuator 70.

The plurality of outlets 20 include a first outlet 20a connected to a radiator (not illustrated) cooling the coolant and a second outlet 20b connected to a reservoir tank (also known as “expansion tank”, not illustrated) removing bubbles in the coolant.

Hereinafter, through the exemplary embodiment in which the at least one rotary valve 40 and the at least one actuator 70 exist one by one, an operational principle of the present disclosure will be described.

Referring to the FIGURE, the rotary valve 40 may include a valve shaft 41 connected to the actuator, and a valve body 43 having at least one through-hole 42 which may communicate with each of the plurality of outlets 20 by rotating the valve shaft 41 and fixedly coupled with the valve shaft 41.

The actuator 70 may be installed in a space which is separated from the water chamber 50 inside or outside the valve housing 30 to be connected to the valve shaft 41. The actuator 70 operates according to a control signal of the controller 60, and as a result, the valve shaft 41 and the valve body 43 which is fixedly coupled with the valve shaft 41 rotate. Since the connection of the actuator 70 and the controller 60 and the control of the rotational angle of the actuator 70 are well known to those skilled in the art, detailed description will be omitted.

A method of fixedly coupling the valve body 43 with the valve shaft 41 may include various methods in addition to a method in which the valve shaft 41 passes through a right end of the valve body 43 to be fixed coupled with the right end as illustrated in the FIGURE. Since this is also the apparent content to those skilled in the art, detailed description will be omitted.

An area in which the at least one through-hole 42 formed in the valve body 43 and the plurality of outlets 20 overlap with each other may vary according to the rotational angle. Accordingly, when using the control valve system 1 for a coolant according to the exemplary embodiment of the present inventive concept, the flow of the coolant which is discharged to the valve housing 30 may be adjusted according to the overlapped area.

When a temperature of the coolant is a first temperature or more, the controller 60 may cool the coolant through the radiator by discharging the coolant to the first outlet 20a. Further, when the temperature of the coolant is a second temperature or more, the controller 60 may remove the bubbles generated in the coolant through the reservoir tank by discharging the coolant to the second outlet 20b. The first temperature and the second temperature may be 90° C.

In a diesel engine vehicle to which the control valve system 1 for the coolant according to the exemplary embodiment of the present inventive concept is applied, as described above, the reference temperatures may be 90° C. However, in various exemplary embodiments, the first temperature and the second temperature may also have different values.

In any case where the first temperature and the second temperature have the same value or different values, it is important that the coolant line connected with the reservoir tank is not a line through which the coolant is flowing all the time.

As described above, in the pressurized type coolant line in the related art, unlike configuring the bubble discharge line by the line through which the coolant is flowing all the time while the coolant is cool and while the coolant is hot, the control valve system 1 for the coolant according to the exemplary embodiment of the present inventive concept prevents the coolant from being discharged through the first outlet 20a and the second outlet 20b while the coolant is cool and allows the coolant to be discharged only while the coolant is hot to shorten the engine warm-up time.

When the bubble exhaust line is used as a line through which the coolant flows all the times, the existing pressurized type coolant line discharges the heat to the outside even while the coolant is cool, but when the bubble exhaust line operates only while the coolant is hot, the heat is discharged to the outside if necessary only while the coolant is hot. The pressurized type coolant line according to the present disclosure may continuously absorb the heat of an engine block or an engine head while the coolant is cool.

However, a criterion for determining whether the coolant is cool or whether the coolant is hot is a relative value which is determined by the first reference temperature and the second reference temperature. Accordingly, the second reference temperature may be different from the first reference temperature transferring the coolant to the radiator. The temperatures may be the same as each other as described above.

Referring to the FIGURE, relative positions of the first outlet 20a and the second outlet 20b will be described below.

The at least one through-hole 42 may be positioned at a different distance from one end of the valve shaft 41 in a length direction thereof. Alternatively, the at least one through-hole 42 may be positioned at the same distance from one end of the valve shaft 41 in the length direction thereof. That is, the position of the at least one through-hole 42 has a correlation with positions of the plurality of outlets 20.

When the at least one through-hole 42 is constituted by only one or by two or more holes formed at the same position in the length direction of the valve shaft 41, the first outlet 20a and the second outlet 20b may be positioned on a cross line of a plane which is vertical to an axis of rotation of the rotary valve 40 and the valve housing 30, so that the first outlet 20a and the second outlet 20b may overlap with the at least one through-hole 42 according to the rotation of the valve shaft 41, respectively.

A line “a” illustrated in the FIGURE is a part of an orbit in which a rotation orbit generated by rotating a center of the through-hole 42 by setting the valve shaft 41 as the axis of rotation extends in a radial direction. As illustrated in the FIGURE, when the first outlet 20a and the second outlet 20b are positioned on the line “a” in parallel, the flow of the coolant may be efficiently adjusted according to the rotation of the rotary valve 40.

In other exemplary embodiments, the first outlet 20a and the second outlet 20b may also be positioned at different distances from one end of the valve shaft 41 in a length direction according to the positions of the at least one through-hole 42. In this case, the first outlet 20a and the second outlet 20b may not be positioned on the line “a” in parallel.

The coolant line, to which the control valve system 1 for the coolant according to the present disclosure is applied, may be generally configured by including a water pump (not shown) circulating the coolant in the coolant line by pressurizing the coolant.

In the reservoir tank which is connected with the second outlet 20b, unlike an expansion tank configured to be connected to the radiator to remove the bubbles when a pressure cap exists in the radiator, a front end thereof is connected with the second outlet 20b and a rear end thereof is connected to the water pump. Accordingly, in this case, the reservoir tank is different from an expansion tank existing in a general coolant line. In the existing pressurized type coolant line, in order that a connection line of the second outlet 20b and the reservoir tank becomes the line through which the coolant is flowing all the times, the reservoir tank needs to have a connection structure as described above because only when the coolant is pressurized by the water pump, the coolant of the connection line may be circulated all the times.

That is, the expansion tank is connected with the coolant line in a single line to remove the bubbles while having a bidirectional flow in the single line according to increase or decrease in the pressure in the coolant line, while the reservoir tank removes the bubbles while the coolant flows in two lines by the water pump while being connected to two lines of the front and rear ends. In addition, according to the exemplary embodiment of the present inventive concept, for rapid engine warm-up, there is a difference in that the flow of the coolant is interrupted while the coolant is cool and operated only while the coolant is hot.

Since the expansion tank is a constituent element which is apparent to those skilled in the art and a function thereof is known well, the difference from the reservoir tank connected with the second outlet 20b of the control valve system 1 for the coolant according to the present disclosure is apparent through the above description.

Until now, the present disclosure has been described in detail through the example of the case where the control valve system 1 for the coolant according to the exemplary embodiment of the present inventive concept includes one rotary valve 40 and one actuator 70, but the exemplary embodiments are not limited to the case and may also include a plurality of rotary valves 40 and one actuator or a plurality of rotary valves 40 and a plurality of actuators. Independent actuators are provided according to the positions of the plurality of outlets 20, respectively to operate the control valve system 1 for the coolant, and the at least one through-hole 42 corresponding to the plurality of outlets 20 rotates with one actuator 70 to the control valve system 1 for the coolant.

The actuator 70 may be a motor of which a rotation angle and a rotation speed are adjusted by the controller, and a various kinds of actuators and link structures in addition the motor may be used as long as the rotary valve 40 may rotate.

As described above, according to the present disclosure, the following effects may be obtained.

First, the engine warm-up time is shortened, cost and weight are reduced, and fuel efficiency is improved by deleting a degassing route which is the line through which the coolant is following all the times.

Second, a package layout of the engine room is simplified.

Third, performance of the heater is improved by shortening the engine warm-up time.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A control valve system for a coolant comprising:
an inlet through which a coolant flows into a water chamber;
a plurality of outlets discharging the coolant outside the water chamber;
a valve housing defining the water chamber which is fluidically connected to the inlet and the plurality of outlets;
at least one rotary valve rotatably installed in the water chamber;
at least one actuator rotating the at least one rotary valve; and
a controller configured to control a flow rate of the coolant discharged to the plurality of outlets by adjusting a rotational angle of the at least one rotary valve by the at least one actuator,
wherein the plurality of outlets include: a first outlet connected to a radiator which cools the coolant; and a second outlet connected to a reservoir tank which removes bubbles of the coolant.

2. The control valve system for the coolant of claim 1, wherein the at least one rotary valve includes:
a valve shaft connected to the at least one actuator; and
a valve body having at least one through-hole which communicates with each of the plurality of outlets by rotation of the valve shaft, the valve body fixedly coupled with the valve shaft.

3. The control valve system for the coolant of claim 2, wherein the flow rate of the discharged coolant is determined according to an area in which the at least one through-hole and the plurality of outlets overlap with each other.

4. The control valve system for the coolant of claim 1, wherein the controller discharges the coolant to the first outlet when a temperature of the coolant is equal to or greater than a first temperature.

5. The control valve system for the coolant of claim 1, wherein the controller discharges the coolant to the second outlet when a temperature of the coolant is equal to or greater than a second temperature.

6. The control valve system for the coolant of claim 1, wherein the first outlet and the second outlet are positioned on a virtual cross line of a plane which is perpendicular to an axis of rotation of the at least one rotary valve.

7. The control valve system for the coolant of claim 1, wherein a front end of the reservoir tank is connected with the second outlet and a rear end of the reservoir tank is connected to a water pump which circulates the coolant by pressurizing the coolant.

8. The control valve system for the coolant of claim 1, wherein the at least one actuator is a motor.

9. The control valve system for the coolant of claim 1, wherein the actuator is spaced apart from the water chamber to be connected to the valve shaft.
